(19) United States
(12) Patent Application Publication
(10) Pub. No.: US 2026/0338355 A1
(43) Pub. Date: Oct. 29, 2026

(54) DOWNLIGHT HAVING DETACHABLE STRUCTURE

(71) Applicant: Wenxing Bi, Guangzhou (CN)

(72) Inventor: Wenxing Bi, Guangzhou (CN)

(21) Appl. No.: 19/704,183

(22) Filed: Jun. 10, 2026

(30) Foreign Application Priority Data
Aug. 1, 2025 (CN) 202521633699.5

(51) Int. Cl. F21V 17/16; F21S 8/02; F21V 13/04; F21V 21/04; F21V 29/503; F21V 29/71

(52) U.S. Cl. CPC F21V 17/162; F21S 8/026; F21V 13/04; F21V 17/164; F21V 29/503; F21V 29/713; F21V 21/047

(57) ABSTRACT

A downlight having a detachable structure. When an outer ring and an inner ring are assembled, a limiting member of an elastic member abuts against an inner wall of an annular track; and when the outer ring and the inner ring are disassembled, the elastic member is elastically deformed in a direction away from the annular track to enable the limiting member to move away from the annular track. This allows for replacement of the downlight without removing the entire lamp and enables all-angle rotation of the downlight.

### CROSS-REFERENCE TO RELATED APPLICATIONS

The present application is a Continuation in part of Chinese Patent Application No. 202521633699.5, filed on Aug. 1, 2025.

### TECHNICAL FIELD

Embodiments of the present application relate to the technical field of lamps, and in particular to a downlight having a detachable structure.

### BACKGROUND

Lamps are daily necessities. Generally, a lamp needs to be connected and fixed to a power cord, such that an external power source can supply power to a light source inside the lamp.

### SUMMARY

To solve or partially solve the problems existing in the related art, embodiments of the present application provide a downlight having a detachable structure, which allows for replacement of the downlight without removing the entire lamp and enables all-angle rotation of the downlight.

The embodiments of the present application provide a downlight having a detachable structure. The downlight includes a detachable structure, a snap ring, and a lighting assembly, where the detachable structure includes:
an outer ring provided with an annular track on an inner wall of the outer ring; and
an inner ring detachably disposed within the outer ring, the inner ring being provided with one or more mounting portions, an elastic member being provided within the mounting portion, a limiting member that protrudes from an outer wall of the inner ring being provided on the elastic member, and the limiting member being configured to be in a detachable fit with the annular track;
when the outer ring and the inner ring are assembled, the limiting member abuts against the annular track; and when the outer ring and the inner ring are disassembled, the elastic member is elastically deformed in a direction away from the annular track to enable the limiting member to disengage from the annular track; and
where the lighting assembly, the snap ring, the inner ring, and the outer ring are nested and mounted from inside to outside.

It should be understood that the above general description and the following detailed description are merely exemplary and illustrative, and should not limit the scope of protection of the present application.

### BRIEF DESCRIPTION OF THE DRAWINGS

The foregoing and other objectives, features and advantages of embodiments of the present application will become more apparent from the more detailed description of the exemplary implementations of the embodiments of the present application with reference to the accompanying drawings. In the exemplary implementations of the embodiments of the present application, like components are generally denoted by like reference signs.

FIG. 1 is an exploded view of a downlight according to an embodiment of the present application;

FIG. 2 is a structural schematic diagram of an inner ring according to an embodiment of the present application;

FIG. 3 is a structural schematic diagram of an outer ring according to an embodiment of the present application;

FIG. 4 is another exploded view of the downlight according to an embodiment of the present application;

FIG. 5 is a structural schematic diagram of the downlight according to an embodiment of the present application;

FIG. 6 is another structural schematic diagram of the downlight according to an embodiment of the present application; and

FIG. 7 is another structural schematic diagram of the downlight according to an embodiment of the present application.

Reference signs: 1. Outer ring; 101. Mounting member; 2. Annular track; 3. Inner ring; 4. Mounting portion; 401. Elastic member; 402. limiting member; 403. First through hole; 5. Fixing member; 6. Middle ring; 601. Second through hole; 7. Snap ring; 701.elastic snap-fit fastener 8. Lighting assembly; 801. Heat sink; 802. Lamp cup; 803. Light source board; 804. Lens; 805. Reflective paper.

### DESCRIPTION OF EMBODIMENTS

Implementations of embodiments of the present application are described in more detail below with reference to the accompanying drawings. Although the implementations of the embodiments of the present application are shown in the accompanying drawings, it should be understood that the embodiments of the present application can be implemented in various forms and should not be limited by the implementations set forth herein. Rather, these implementations are provided for a more thorough and complete understanding of the embodiments of the present application, and for fully conveying the scope of the embodiments of the present application to those skilled in the art.

Terms used in the embodiments of the present application are merely for the purpose of describing specific embodiments, but are not intended to limit the embodiments of the present application. Singular forms “a/an” and “the” used in the embodiments of the present application and the appended claims are also intended to include plural forms, unless otherwise clearly indicated in the context. It should also be understood that the term “and/or” as used herein refers to and includes any or all possible combinations of one or more of the associated listed items.

It should be understood that although the terms “first”, “second”, “third”, etc. may be used in the embodiments of the present application to describe various information, such information should not be limited to these terms. These terms are merely used to distinguish items of information of the same type from each other. For example, first information could also be referred to as second information, and similarly, second information could also be referred to as first information, without departing from the scope of the embodiments of the present application. Thus, the features defined with “first” and “second” may explicitly or implicitly include one or more features. In the description of the embodiments of the present application, the phrase “a plurality of” means two or more, unless otherwise explicitly and specifically defined.

In related art, the removal and replacement of a downlight usually require removing the entire lamp, which is not only complicated to operate, but also easily causes damage to the lamp itself and an installation base. For example, repeated removal and installation will lead to deformation of the lamp and wear of mounting points, thus affecting the aesthetics and service life of the lamp. In addition, the existing downlights have a relatively limited angle adjustment function, and can usually only be finely adjusted via snap points and cannot achieve 360° free rotation, which limits the flexible adjustment of lighting direction.

In view of the above problems, embodiments of the present application provide a downlight having a detachable structure, which allows for replacement of the downlight without removing the entire lamp and enables all-angle rotation of the downlight, thereby improving the practicality.

The technical solution of the embodiments of the present application will be described in detail below with reference to the accompanying drawings.

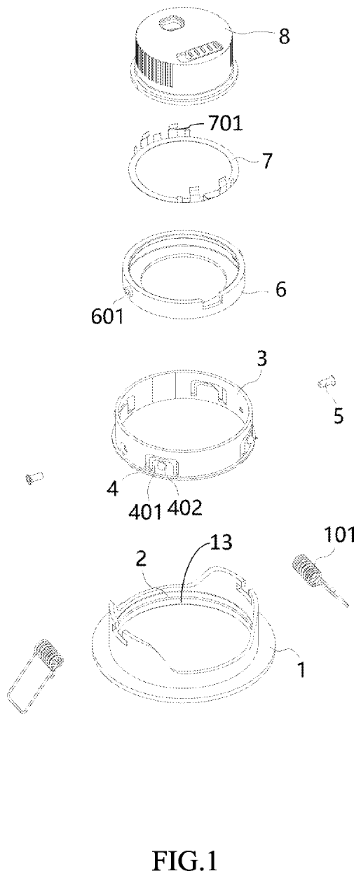

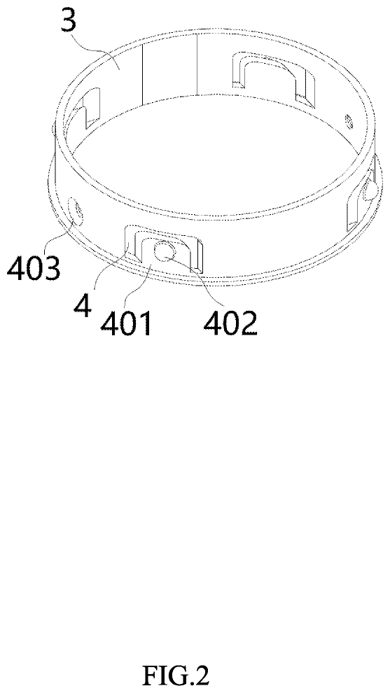

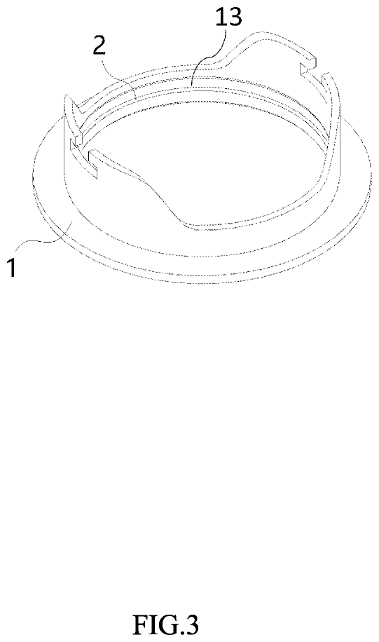

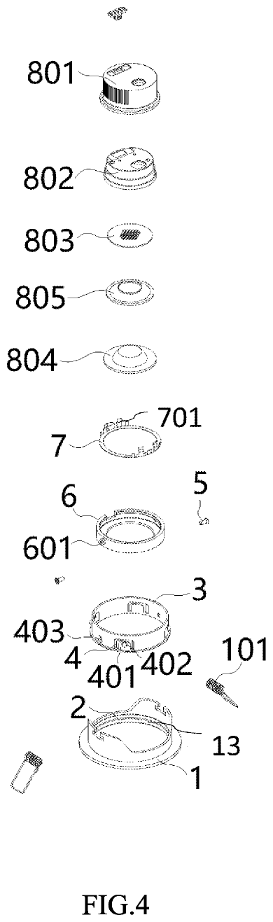

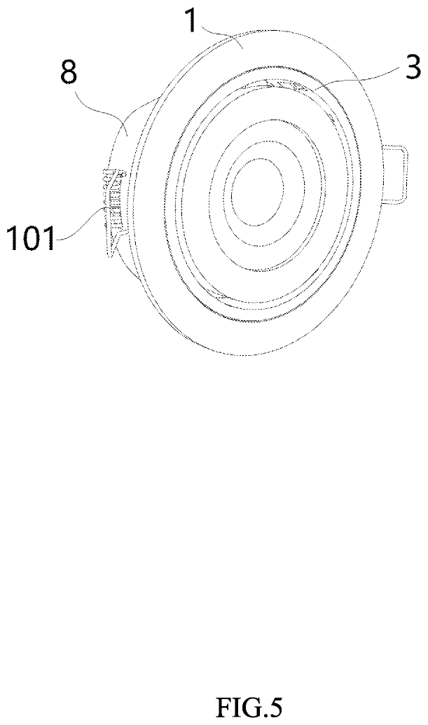

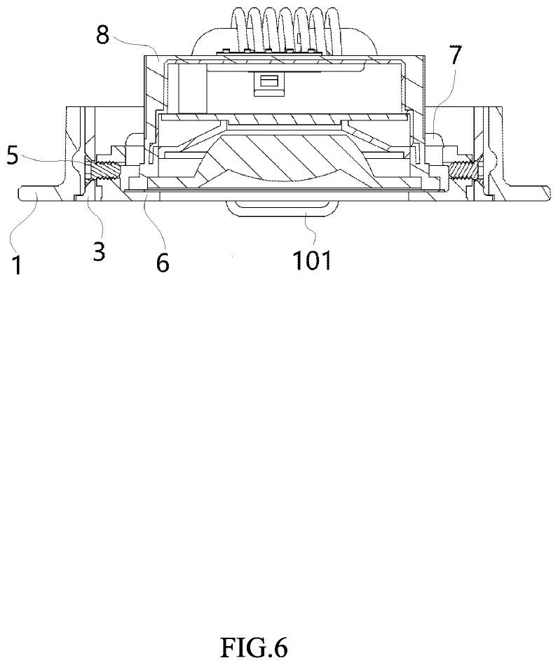

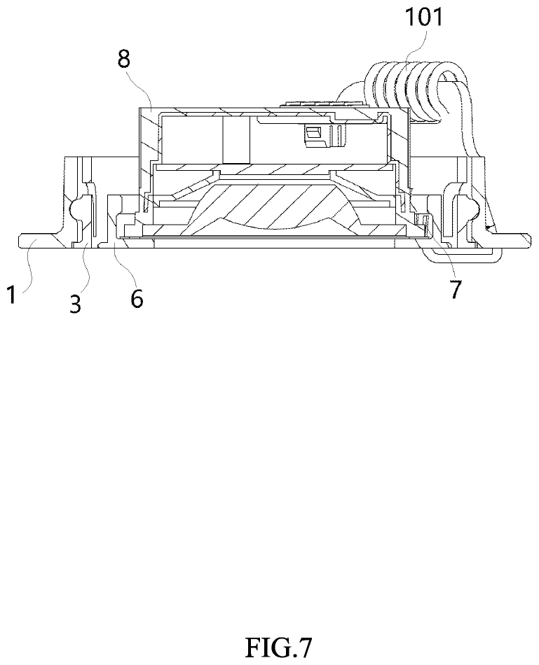

Referring to FIGS. 1 to 7, a downlight having a detachable structure includes a detachable structure, a snap ring, and a lighting assembly. The detachable structure includes:
an outer ring 1 provided with an annular track 2 on an inner wall of the outer ring 1; and
an inner ring 3 detachably disposed within the outer ring 1, the inner ring 3 being formed with at least one hollowed-out mounting portion 4, an elastic member 401 being provided within the mounting portion 4, a limiting member 402 that protrudes from the elastic member 401 being provided on the elastic member 401, and the limiting member 402 being configured to fit with the annular track 2;
where when the outer ring 1 and the inner ring 3 are assembled, the limiting member 402 of the elastic member abuts against an inner wall of the annular track 2; and when the outer ring 1 and the inner ring 3 are disassembled, the elastic member 401 is elastically deformed in a direction away from the annular track 2 to enable the limiting member 402 to move away from the annular track 2; and
where the lighting assembly 8, the snap ring 7, the inner ring 3 and the outer ring 1 are nested and mounted from inside to outside. The downlight can be applied in scenarios such as ceilings and recreational vehicles, which is not limited herein.

Specifically, the annular track 2 may be a groove structure on the inner wall of the outer ring 1, specifically an annular continuous groove or spaced recesses, for accommodating the limiting member 402. The mounting portion 4 may be a hollow-out area circumferentially disposed on the inner ring 3. The elastic member 401 is disposed in the mounting portion 4, and other areas in the mounting portion 4 besides the elastic member 401 may form a U-shaped opening or a rectangular through hole and can provide deformation space for the elastic member 401.

Specifically, the elastic member 401 can deform under the drive of an external force, and the limiting member 402 may be a protruding structure disposed at the end of the elastic member 401 and can form a point-contact or surface-contact fit relationship with the annular track 2. During the assembly process, when the inner ring 3 is pushed into the outer ring 1, the elastic member 401 undergoes elastic deformation under compression, and the limiting member 402 slides into the annular track 2 along the inner wall of the outer ring 1 to achieve locking. During disassembly, pressure is applied to the elastic member 401, and upon disengagement of the limiting member 402 from the annular track 2, the inner and outer rings 1 can be separated. The amount of deformation of the elastic member 401 is controlled within an elastic limit of material, ensuring that the elastic member can return to its initial shape even after repeated assembly and disassembly. Through the deformation of the elastic member 401, the inner ring 3 and the outer ring 1 can be quickly disassembled, and then a light source can be removed more quickly, so that there is no need to remove the entire downlight from a ceiling and then replace the downlight.

Further, the inner ring 3 and the outer ring 1 may be manufactured by an integral molding process. The inner ring 3 and the outer ring 1 may be made of resin, plastic, etc., and the outer ring 1 may also be made of a metal such as iron or aluminum, which will not be limited herein. Further, the elastic member 401 may be mounted into the mounting portion 4 by another process after the inner ring 3 is manufactured. For example, the elastic member 401 may be made of a material that can undergo elastic deformation, such as a phosphor bronze sheet, a spring steel sheet, a resin material, or polymer plastic. Alternatively, the elastic member may be manufactured together with the inner ring 3 by an integral molding process.

Further, the inner ring 3 (with the mounting portion 4 having not yet been provided within the inner ring 3) may be manufactured as a whole, and then the mounting portion 4 may be formed in the inner ring 3.

Specifically, a diameter of the inner ring 3 is less than a diameter of the outer ring 1, such that the inner ring 3 can be mounted within the outer ring 1.

Specifically, when the limiting member 402 abuts within the annular track 2, the stable match between the inner ring 3 and the outer ring 1 may be achieved, and by rotating the inner ring 3, the limiting member 402 can move within the annular track 2 of the outer ring 1 to allow for the inner ring 3 to rotate better, enabling subsequent all-angle rotation irradiation of the lighting assembly 8 under the drive of the inner ring 3.

In a possible implementation, a plurality of mounting portions 4 are evenly distributed in a circumferential direction of the inner ring 3.

Specifically, the even distribution in the circumferential direction refers to being circumferentially arranged at equal intervals on the annular structure of the inner ring 3. For example, mounting portions 4 are provided along the circumference of the inner ring 3 at fixed angular intervals. An elastic member is provided within each mounting portion 4. A plurality of mounting portions 4 may be provided, and the number can be set according to actual needs, which will not be limited herein.

Specifically, with the plurality of mounting portions 4 being evenly distributed along the circumference of the inner ring 3, the elastic members 401 within the mounting portions 4 can synchronously generate elastic deformation, so as to enable the limiting members 402 to evenly contact the inner wall of the annular track 2 when the outer ring 1 and the inner ring 3 are assembled. Such a layout enables balanced distribution of the contact force between the inner ring 3 and the outer ring 1 in the circumferential direction, so as to avoid structural deformation caused by excessive local stress. When disassembly is required, a user can apply force evenly to make the plurality of elastic members 401 synchronously disengage from the annular track 2, thereby reducing the force required for a single-point operation.

In a possible implementation, the plurality of mounting portions 4 are symmetrically arranged in the inner ring 3.

Specifically, the symmetrical arrangement may be referred to forming a mirror distribution based on a central axis in the circumferential direction of the inner ring 3, for example, employing four groups of mounting portions 4 arranged at 90-degree intervals, and when the mounting portions 4 are arranged symmetrically along the axis of the inner ring 3, the deformation directions of the elastic members 401 form a complementary relationship. When a disassembly force is applied, the symmetrically distributed elastic members 401 undergo coordinated deformation, causing the limiting members 402 to synchronously disengage from the annular track 2 of the outer ring 1. Such a symmetrical layout allows for a disassembly operation without requiring a specific angle of force, and applying tension in any direction can trigger a synchronous action of the symmetrically positioned elastic members 401. During an assembly process, the symmetrically arranged limiting members 402 can form multi-point contact with the annular track 2 of the outer ring 1 simultaneously, so as to avoid an eccentric load phenomenon caused by single-sided contact.

In a possible implementation, the limiting member 402 is spherical in shape, and the limiting member 402 is slidable within the annular track 2.

Specifically, the limiting member 402 being spherical in shape refers to the limiting member 402 being of a spherical structure in appearance. Such a spherical structure allows for the limiting member 402 to slide better within the annular track 2, so as to reduce the frictional resistance with the inner wall of the annular track 2. The annular track 2 may be a sliding groove. When the inner ring 3 and the outer ring 1 are assembled, the spherical limiting member 402 is embedded into the sliding groove of the annular track 2, and the limiting member 402 is maintained in contact with the sliding groove under an elastic force of the elastic member 401. When the relative angle between the inner ring 3 and the outer ring 1 needs to be adjusted, the inner ring 3 can rotate around the axis of the outer ring 1, and then the spherical limiting member 402 rolls or slides along the sliding groove, thereby achieving multi-angle adjustment. During a disassembly process, the elastic member 401 is deformed under compression to cause the limiting member 402 to disengage from the sliding groove, and the inner ring 3 can be directly pulled out.

In a possible implementation, a fixing member 5 is further included, the inner ring 3 is formed with a first through hole 403, and the fixing member 5 can be inserted into the first through hole 403.

Specifically, the fixing member 5 refers to a fastening part configured to connect the inner ring 3 with other assemblies, and may be a screw, a pin, or a snap-fit structure. The first through hole 403 refers to a hole running through a surface of the inner ring 3, specifically a circular, square or polygonal hole structure, and functions to provide an insertion path for the fixing member 5 to achieve a positioning function. Through the cooperation of the fixing member 5 and the through hole, the inner ring 3 can be tightly connected to other components. The fixing member 5 may be a 10-15 mm self-tapping screw with a diameter that matches the through hole.

Specifically, the inner ring 3 is detachably connected to the fixing member 5 via the first through hole 403. During the assembly process, the fixing member 5 passes through the first through hole 403 of the inner ring 3 and is fixed to an external assembly. For example, when the inner ring 3 needs to be connected to the middle ring 6, the fixing member 5 can be inserted into their through holes to form a constraint. During disassembly, disconnection can be achieved simply by pulling the fixing member 5 out of the through holes.

In a possible implementation, the middle ring 6 is formed with a second through hole 601 that matches the first through hole 403, and the fixing member 5 can be inserted into the first through hole 403 and the second through hole 601 to enable the inner ring 3 and the middle ring 6 to be fixedly mounted.

Specifically, the second through hole 601 refers to a hole structure running through a surface of the middle ring 6, and is positioned and sized completely corresponding to the first through hole 403 of the inner ring 3, for example, a circular hole with a diameter ranging from 2 to 5 mm, which is formed by machining. During the assembly process, the first through hole 403 of the inner ring 3 is positioned to align with the second through hole 601 of the middle ring 6 by a rotation or translation operation, and subsequently the fixing member 5 is inserted into their through holes. The insertion of the fixing member 5 creates a rigid connection between the inner ring 3 and the middle ring 6 to avoid relative displacement.

In a possible implementation, at least one mounting member 101 is provided on the outer ring 1.

Specifically, the mounting member 101 refers to an assembly for fixing or connecting the outer ring 1 to other external structures, and is, for example, a spring clip. The mounting member 101 can provide support between the outer ring 1 and an external support structure to prevent the outer ring 1 from shifting due to uneven stress after assembly, and enable the downlight, which is formed by means of the outer ring 1, to be embedded and mounted into the ceiling. For example, when the mounting member 101 is a snap-fit fastener, a protruding portion of the snap-fit fastener can be embedded into a mounting hole reserved in the ceiling, such that a fixing force is generated by elastic deformation; and when disassembly is required, unlocking can be achieved by pressing a release end of the snap-fit fastener, so as to enable the outer ring 1 to be quickly mounted or removed without using auxiliary tools.

In a possible implementation, the inner wall of the outer ring 1 is further provided with a limiting step 13. The limiting step 13 is located below the annular track 2 and is configured to abut against the middle ring 6 when the outer ring and the middle ring 6 are assembled.

The detachable structure in the embodiments of the present application is mainly for use in recessed lamps such as downlights, spotlights, and ceiling lights. Specifically, the main body portion of the lamp is mounted and fixed to the inner ring 3, and the rotation of the inner ring 3 enables the main body portion of the lamp to rotate relative to the outer ring 1 at a rotation angle that enables all-angle rotation.

In a downlight having a detachable structure according to an embodiment of the present application, the detachable structure includes: an outer ring 1 provided with an annular track 2 on an inner wall of the outer ring 1; and an inner ring 3 detachably disposed within the outer ring 1, the inner ring 3 being formed with at least one hollowed-out mounting portion 4, an elastic member 401 being provided within the mounting portion 4, a limiting member 402 that protrudes from the elastic member 401 being provided on the elastic member 401, and the limiting member 402 being configured to fit with the annular track 2; when the outer ring 1 and the inner ring 3 are assembled, the limiting member 402 of the elastic member abuts against an inner wall of the annular track 2; and when the outer ring 1 and the inner ring 3 are disassembled, the elastic member 401 is elastically deformed in a direction away from the annular track 2 to enable the limiting member 402 to move away from the annular track 2. This allows for replacement of the downlight without removing the entire lamp and enables all-angle rotation of the downlight, thereby improving the practicality.

Specifically, the snap ring 7 refers to an annular component for fixing the lighting assembly 8, and may be specifically a plastic member having an elastic snap-fit fastener 701. The lighting assembly 8 refers to an illumination module including a light source, and may be specifically formed by a heat sink 801, a lamp cup 802, a light source board 803, and a lens 804.

Specifically, the lighting assembly 8 is fixed to the innermost layer by means of the snap ring 7, the snap ring 7 is connected to the middle ring 6 by means of the elastic snap-fit fastener 701, the middle ring 6 is connected to the outer ring 1 by means of a screw or a clamping member, and the inner ring 3 fits with the annular track 2 of the outer ring 1 by means of the limiting member 402 to form a detachable structure. During assembly, the lighting assembly 8 is first embedded into the snap ring 7, the snap ring 7 is then snapped into the middle ring 6 to form a fixed connection, the middle ring 6 is connected to the inner ring 3 by means of the fixing member 5, and the inner ring 3 is connected to the outer ring 1 via the mounting portion 4, thereby forming a stable structure nested layer by layer. During disassembly, the lighting assembly 8 is separated from the outer ring 1 by only releasing the limiting fit between the inner ring 3 and the outer ring 1, and then other components are separated layer by layer, making it more convenient to remove the lighting assembly 8. In the related art, it is necessary to remove the outer ring 1 from the ceiling and then separate the lighting assembly 8, which makes the operation too cumbersome and easily causes damage to the ceiling, thus reducing the service life of the lamp.

In a possible implementation, the lighting assembly 8 includes a heat sink 801, a lamp cup 802, a light source board 803, and a lens 804. The lamp cup 802 is mounted at a lower end of the heat sink 801, the light source board 803 is disposed within the lamp cup 802, and the lens 804 is located at a front end of the light source board 803.

Specifically, a switch may be provided at an upper end of the heat sink 801 for adjusting color temperature of the lighting assembly 8. The heat sink 801 may be a metal component for conducting and dissipating the heat generated by the light source board 803. The lamp cup 802 refers to a cup-shaped container for accommodating the light source board 803, for example, an aluminum housing with its inner wall coated with a reflective material, which reflects light to improve the light efficiency utilization rate. The light source board 803 is a circuit board that carries light-emitting elements, and can use a highly thermally conductive material to reduce thermal resistance. The lens 804 is an optical element for controlling light distribution, for example, a Fresnel lens 804 formed by injection molding of polycarbonate, which can optimize curvature to control a beam angle. The lamp cup 802 is fixed to a bottom open end of the heat sink 801 in a threaded manner or in a snap-fit manner, forming a sealed cavity. The light source board 803 is bonded to an inner bottom surface of the lamp cup 802 by means of a thermally conductive adhesive layer to ensure heat transfer to the heat sink 801. The lens 804 is embedded at a front end opening of the lamp cup 802 via an annular slot, and maintains a preset distance from the light source board 803 to form a collimated optical path.

In a possible implementation, the lighting assembly 8 further includes reflective paper 805. The reflective paper 805 is bonded to an outer wall of the lens 804.

Specifically, the reflective paper 805 is made of a thin film material having a light reflection function, for example, made of an aluminized polyester thin film or a metalized PET material, has its surface embossed to enhance the diffuse reflection effect, and is configured, in the lighting assembly 8, to redirect the light scattered inside the lens 804 to a target area. The reflective paper 805 is bonded to the outer wall of the lens 804, and the reflective paper 805 reflects the light emitted by the light source board 803, so as to improve the brightness and lumen of the lamp.

The foregoing descriptions are only specific implementations of the embodiments of the present application. It can be clearly understood by those skilled in the art that, for convenience and brevity of description, for the specific operation processes of the systems, modules and units described above, reference can be made to the corresponding processes in the foregoing method embodiments, which will not be repeated herein. It should be understood that the scope of protection of the embodiments of the present application is not limited herein. Any equivalent modification or replacement readily figured out by those skilled in the art within the technical scope disclosed in the embodiments of the present application shall fall within the scope of protection of the embodiments of the present application.

What is claimed is:

1. A downlight having a detachable structure, the downlight comprising a detachable structure, a snap ring, and a lighting assembly, wherein the detachable structure comprises:
an outer ring provided with an annular track on an inner wall of the outer ring; and
an inner ring detachably disposed within the outer ring, the inner ring being provided with one or more mounting portions, an elastic member being provided within the mounting portion, a limiting member that protrudes from an outer wall of the inner ring being provided on the elastic member, and the limiting member being configured to be in a detachable fit with the annular track; and
when the outer ring and the inner ring are assembled, the limiting member abuts against the annular track; and when the outer ring and the inner ring are disassembled, the elastic member is elastically deformed in a direction away from the annular track to enable the limiting member to disengage from the annular track;
wherein the lighting assembly, the snap ring, the inner ring, and the outer ring are nested and mounted from inside to outside.

2. The downlight according to claim 1, wherein a plurality of mounting portions are evenly distributed in a circumferential direction of the inner ring.

3. The downlight according to claim 1, wherein the plurality of mounting portions are symmetrically disposed in the circumferential direction of the inner ring.

4. The downlight according to claim 1, wherein an outer surface of the limiting member is spherical, enabling the limiting member to slide within the annular track.

5. The downlight according to claim 1, further comprising a fixing member and a middle ring, wherein the inner ring is formed with a first through hole, the middle ring is formed with a second through hole that matches the first through hole, and the fixing member is capable of being inserted into the first through hole and the second through hole to enable the inner ring and the middle ring to be fixedly mounted.

6. The downlight according to claim 1, wherein at least one mounting member is provided on the outer ring, the mounting member being configured to enable installation of the downlight.

7. The downlight according to claim 1, wherein the lighting assembly comprises a heat sink, a lamp cup, a light source board, and a lens, the lamp cup being mounted at a lower end of the heat sink, the light source board being disposed within the lamp cup, and the lens being located at a front end of the light source board.

8. The downlight according to claim 7, wherein the lighting assembly further comprises reflective paper bonded to an outer wall of the lens.

9. The downlight according to claim 5, wherein the snap ring is annular, is configured to fix the lighting assembly, and is provided with an elastic snap-fit fastener that snaps into the middle ring.

10. The downlight according to claim 9, wherein a plurality of elastic snap-fit fasteners are provided and have different heights.

11. The downlight according to claim 5, wherein the inner wall of the outer ring is further provided with a limiting step that is located below the annular track and configured to abut against the middle ring when the outer ring and the middle ring are assembled.
